(19) United States
(12) Patent Application Publication
(10) Pub. No.: US 2004/0049857 A1
(43) Pub. Date: Mar. 18, 2004

(54) Treatment of part processed leather

(76) Inventor: Rod Stosic, Sandringham (AU)

Correspondence Address: ROTHWELL, FIGG, ERNST & MANBECK, P.C., 1425 K STREET, N.W., SUITE 800, WASHINGTON, DC, 20005, US

(21) Appl. No.: 10/343,923

(22) PCT Filed: Aug. 7, 2001
(86) PCT No.: PCT/GB01/03538

(30) Foreign Application Priority Data
Aug. 7, 2000 (GB) 0019296.3

(51) Int. Cl. C14C 1/00

(52) U.S. Cl. 8/94.15

(57) ABSTRACT

Dispersion of a desired compounds, in particular a fungicide, in a leather treatment solution is improved by introducing the compound into the solution in the form of a solid tablet or block comprising the compound dispersed in a sparingly water soluble carrier.

This invention relates to a method for delivery of an agent, especially a fungicide, onto leather within a tannery vessel, and in particular to a formulation for such treatment.

Leather is produced by stabilising the skin with tanning agents. Traditionally vegetable tannins were used for this purpose but salts of chromium have become more common; wet blue leather (that is, leather which after (chrome) tanning has not been significantly further processed, and is sold in the wet condition) is increasingly used as a commodity and therefore shipped around the world. The high moisture content and low pH of wet blue leather however is congenial for mould growth.

The most convenient method for preventing mould growth is to employ a fungicide. Regulatory actions of government bodies have however curtailed the use of many of the more traditional fungicides (for example the banning of organomercurial compounds and the restrictions of certain phenolic materials). These pressures have resulted in alternative fungicides being introduced to the leather industry, but which are not specifically suited to the purpose.

Two of the more widely accepted organic compounds that have substituted traditional fungicides are TCMTB (2-(thiocyanomethylthio)-benzothiazole (or (2-benzothiazolythio)methyl thiocyanate) and 2-n-octyl isothiazolin-3-one. These fungicides have been shown to be effective on a laboratory scale at preserving partially tanned leather.

Some studies (Stosic R. G., Stosic P. J., Covington A. D. and Alexander K. T. W. (1993) JALCA Vol 88 p169) have highlighted a problem in that, when working with a large-scale system, such as in a tannery vessel, there is a distinct and finite time for chemicals to-mix with the process solution. On the one hand these organic fungicides are rapidly taken up by the wet blue leather whereas studies of the fungicide distribution across the vessel have revealed that the active ingredient (fungicide) can take as long as 30 to 40 minutes to reach equilibrium in the tanning liquor, by which time the majority of fungicide is already absorbed by the hides. The rapid intake of these chemicals confirms laboratory scale investigations (Fowler W M and Russell A E (1990) JALCA 85:243).

The variation in concentration of these fungicides across the vessel (or drum) manifests itself in a wide range of fungicide concentrations within the treated leather. Those hides on the side of the drum at which the fungicide was added were found to receive a higher dose of the fungicide than those at the opposite side of the vessel. For example, in a controlled trial, 10 hides were analysed for TCMTB content and after treatment the range of fungicide concentrations in the 10 hides was found to be 0.42-95 ppm.

The movement of the leather within a tanning vessel is important and its influence on the reaction rates of the process chemical is affected by a number of variables including drum speed, internal geometry and fixtures and load to float ratio. Rapid, thorough mixing of the liquor, especially for materials added through the axle of the drum, is of the greatest importance, and is more important than lifting and falling of the hides. Despite the merits of fast drum rates and the resulting improved mixing, drumming action is most favourable when the drum contents are processed without putting too great a strain upon the hides, thereby causing mechanical damage to the fibre structure.

This invention is based on the realisation that the solution to better distribution is slower release of the active ingredient, e.g. fungicide into the tanning liquor, and this may be achieved by mixing the active ingredient (fungicide) with a supporting medium in such a way as to form a solid block or tablet which will dissolve in a controlled manner over time. This novel approach of applying active ingredients such as fungicides to tannery vessels is more cost effective than other slow release techniques such as encapsulation, which is an expensive process. The method of this invention also reduces a number of health and safety problems associated with fungicides currently in regular use.

According to one aspect of the present invention there is provided a method of treating, leather with active ingredients such as a fungicide in which the, active ingredient is introduced into a drum containing the leather and water as a solid tablet or block comprising the active ingredient dispersed in a sparingly water soluble carrier.

The process of this invention may also be used to introduce other leather treatment chemicals other than fungicides during drumming, such as dyes or brightening agents.

A suitable carrier material for use in this invention most preferably has the following properties:

(a) Compatibility with the fungicide, or other agent

(b) Sparing solubility in water

(c) Melting point above 50° C.

(d) Chemically relatively inert, does not react with chrome or other tanning ions (i.e. does not act as a ligand) or absorb on the leather (such absorption could affect subsequent processing, such as dyeing).

Simple materials which conforms-to all these requirements are long chin alcohols and diols. Other more complex materials such as polyalkylene oxides may also form suitable carriers for this invention.

A tablet or block comprising a fungicide, or other leather treatment chemical, dispersed in a sparingly water soluble carrier, forms another aspect of this invention.

Many of the modern fungicides used in the tanning industry are solid at room temperature and are usually dissolved in a carrier liquid. This is done to dilute the material to a practical working concentration, to avoid the problems associated with handling powders (at the expense of associated problems of handling a liquid). The solution of fungicide in the carrier liquid is added to the tanning vessel. In a preferred method of preparing the tablets or blocks according to the invention, the active ingredient, especially fungicide, and supporting medium or media may be ground to a powder and mixed thoroughly. There is no limit to the ratio of active ingredient to support media, but the amount of active ingredient will affect the rate of dissolution and the required dimensions of the block. The mixture is then heated to the temperature at which the support medium melts. Once completely melted, the mixture is allowed to solidify forming a solid block, or advantageously is solidified in moulds to form shaped blocks or tablets.

The rate of active ingredient (fungicide) release can be controlled in at least two ways. The first involves altering the size of the tablets. The smaller the tablets the greater the surface area to weight ratio and so the quicker the dissolution time will be. The second method is to alter the composition of the supporting medium in order to vary its solubility characteristics in the tanning liquor. An example of this is to alter the length of the carbon chain or the amount of unsaturation of the chain if fatty alcohols are used as the supporting media. As it is likely that blends will be used commercially (cuts, for example C14-C20, instead of a single defined species such as C18) altering the blend will serve a similar purpose. In this case the more of the shorter length alcohols in the medium, the more rapidly the block will dissolve in the tanning liquor.

In the case of fungicide addition, the tablet is added to the tanning vessel at the typical usual point of fungicide application, such as the basification step. As it dissolves at the desired rate it will gradually release the active fungicide to the tanning vessel. As the processing continues, the tablet will move about the tanning vessel (as will the leather) and both will be mixed intimately, ensuring more uniform distribution of the fungicide across the vessel and hence onto the leather. The time of dissolution can vary, depending on the formulation; typical times are 3-4 hours. Typically, a plurality of tablets or blocks are added to the tanning vessel, depending on the size of the vessel, the quantity of hides and the desired fungicide composition. The number of blocks is preferably in the range of from 5 to 50, preferably from about 10 to 30 and especially about 20.

This method of application has a number of, additional advantages over the traditional fungicide application methods. Firstly, by binding the active ingredient (fungicide) in a solid medium, there will be no fumes when applying the fungicide to the tanning vessel. The chance of the operator being contaminated is also greatly reduced because no splashes, or spillage (either in diluting the fungicide or in applying it to the tanning vessel) can occur. Handling will be greatly simplified; the operative will unwrap the desired number of blocks, typically of around 0.5 kg each, and drop them into the drum. As the chemical is released slowly, the amount of, active in the tanning liquor at any time is low, thereby reducing health and safety implications.

This method also eliminates the need for additional solvents and surfactants which are often used in fungicide formulations and which can create environmental problems in their own right.

Although this invention is primarily concerned with the application of fungicides, the slow release mechanism as described here may be used to control the release of other chemicals within a tannery vessel, providing they are compatible with the inert carrier media.

The invention is further illustrated by the following examples.

### EXAMPLE 1

Tablets were produced from four carrier materials:

octadecanol, 1,10-decanediol, 1,8-octanediol and 1,6-hexanediol. Each carrier was melt-blended with the active fungicide 2-(thiocyanomethylthio)—benzothiazole at a ratio of 4:1 by weight, to provide a blend containing 20% by weight of fungicide. The heated blend was allowed to solidify in moulds to form tablets or around 1 gm and around 70 gms in weight.,

Another set of tablets was prepared using the same carriers and a dyestuff to act as a visual marker, in the same proportions as above.

### EXAMPLE 2

Laboratory scale treatment consisted of placing leather pieces' and 1 gm fungicide tablets prepared in Example 1 (broken where necessary so that the weight of tablet used was 0.05% of the weight of the Leather to be treated) in a small drum and turning it until the tablet was completely dissolved.

Results showed that the hexanediol and octanediol dissolved rapidly over the first 1.0-1.5 hours (the hexanediol more rapidly than the octanediol). The decanediol was, completely dissolved at the end of the four-hour treatment while a few small particles of the octadecanol were present at the end of treatment. This effectively follows the relative solubility of each of the four materials, the most soluble material dissolving the quickest.

Trials carried out using 1 gm tablets prepared in Example 1 and containing the dyestuff produced a visually level shade over the leathers, indicating that under the laboratory conditions the tablet succeeded in distributing the dye (and therefore the fungicide in the previous test) over the leather successfully.

### EXAMPLE 3

Twelve commercially produced wet blue hides were taken from a tannery at the end of tanning, prior to neutralisation, sided and labelled. One side of each hide was treated using 70 gm fungicide tablets containing 20% active fungicide (0.05% on the weight of the leather) while the other side was conventionally treated with fungicide (0.1% on the weight of the leather weight). The sides were treated overnight (for the duration of the neutralisation). The temperature was held at 25° C. during this time, before being raised to 40° C. for the final two hours. The hides were then re-introduced to the commercial production and processed through to crust leather. The hides were reclaimed at the end of processing and evaluated with regards to any effects the fatty alcohol may have bad on the finished leather.

No visible effects were seen on the leather. Subsequent dye uptake was the same as the rest of the pack, as was handle and all other physical properties. It can be concluded that the novel application method had no adverse effects on subsequent processing of the leather.

### EXAMPLE 4

i). One sample of tanning liquor and three samples of leather were taken from a tanning drum containing eleven tonnes of hides. The leather samples were taken from the middle of separate hides.

ii) TCMTB fungicide blocks were added to the drum by evenly distributing the blocks over the, surface of the liquor and hides. In total, forty blocks were added each of 500 g weight, measuring 65 mm in length by 100 mm diameter and comprising 20% TCMTB.

iii) One sample of liquor and three samples of leather were repeatedly taken from the drum at hourly time intervals until the end of the tanning process.

iv) Steps 1 to 3 were repeated in a separate tanning process where 20 kg Standard TCMTB liquid was added in place of the TCMTB blocks. The standard TCMTB liquid comprised 20% TCMTB.

Method of Analysis:

One small sample of leather (approximately 2.5 cm²) was removed from the neck end of each piece of leather by scalpel, dried at 50° C. for 24 hours, accurately weighed and extracted using acetonitrile. The extracts were analysed using HPLC and the amount of TCMTB was quantified.

Leather samples were als, analysed at the microbiological laboratory for Fungicidal efficacy.

The tanning liquor was analysed by standard HPLC techniques.

Results

Leather Analysis:

TABLE 1
TCMTB (ppm) content of leather samples undergone treatment with TCMTB Blocks

| | | Time (hours) following addition of TCTMB Blocks | | | | | | | |
|---|---|---|---|---|---|---|---|---|---|
| | Sample | 0 | 1 | 2 | 3 | 4 | 5 | 6 | 7 |
| TCMTB | A | 8.39 | 87.8 | 350 | 189 | 247 | 368 | 233 | 243 |
| Content | B | 7.74 | 124 | 222 | 302 | 204 | 167 | 286 | 344 |
| (ppm) | C | | 62.6 | 153 | 196 | 335 | 277 | 229 | 321 |
| | Averag | 8.065 | 91.46 | 241.66 | 229 | 262 | 270.67 | 249.33 | 302.66 |
| | ST Dev. | 0.45 | 30.86 | 99.96 | 63.31 | 66.77 | 100.65 | 31.81 | 52.93 |

TABLE 2
TCMTB (ppm) content of leather samples undergone treatment with TCMTB liquid
Time (hours) following addition of TCTMB Blocks

| | Sample | 0 | 1 | 2 | 3 | 4 | 5 | 6 | 7 |
|---|---|---|---|---|---|---|---|---|---|
| TCMTB | A | 0 | 341.669 | 283.804 | 1702.436 | 506.142 | 360.618 | 449.417 | 168 |
| Content | B | 0 | 396.218 | 225.453 | 509.007 | 722.697 | 380.941 | 534.054 | 238 |
| (ppm) | C | 0 | 570.692 | 268.012 | 261.075 | 452.455 | 356.521 | 812 | 523 |
| | Averag | 0 | 436.193 | 259.0897 | 824.1727 | 560.4313 | 366.0267 | 598.4903 | 309.6667 |
| | ST Dev. | 0 | 119.6302 | 30.18138 | 770.6344 | 143.0671 | 13.07763 | 189.6856 | 188.0381 |

Liquor Analysis:

TABLE 3
TCMTB Content of liquor samples in ppm.

| | | Time (hours) following addition of TCTMB Blocks | | | | | | | |
|---|---|---|---|---|---|---|---|---|---|
| | Sample | 0 | 1 | 2 | 3 | 4 | 5 | 6 | 7 |
| TCMTB | Blocks | 0 | 230 | 140 | 260 | 130 | 190 | 60 | 70 |
| (ppm) | Liquid | 0 | 11.7 | 8.2 | 8.4 | 7.8 | 7.6 | 7.2 | 6.9 |

In the attached figures:

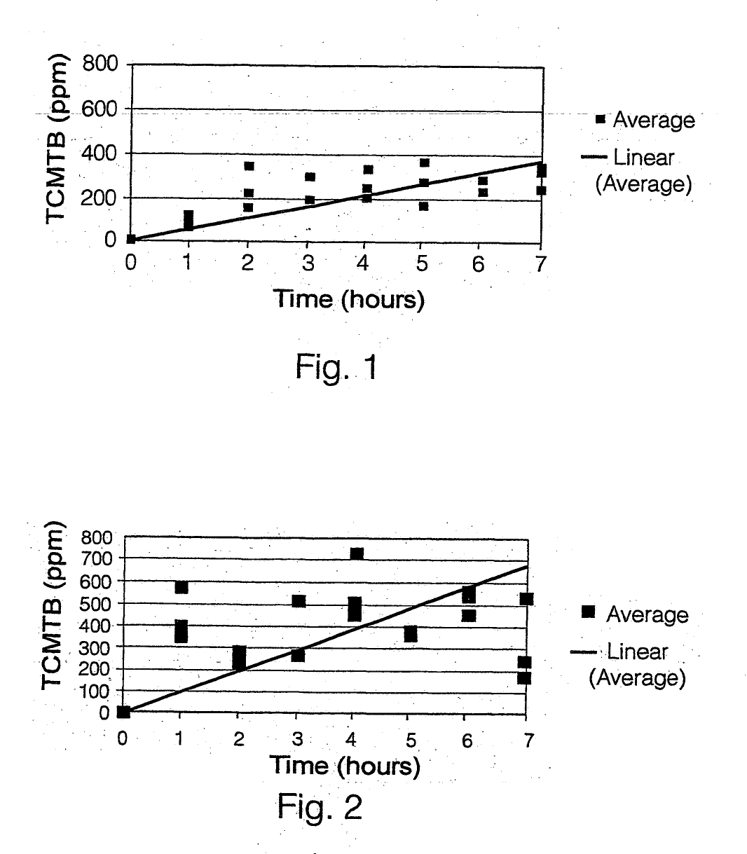

FIG. 1 is a graphical representation of the results from Table. 1, showing the average values and trend line;

FIG. 2 is a graphical representation of the results from Table 2, showing the average values and trend lines;

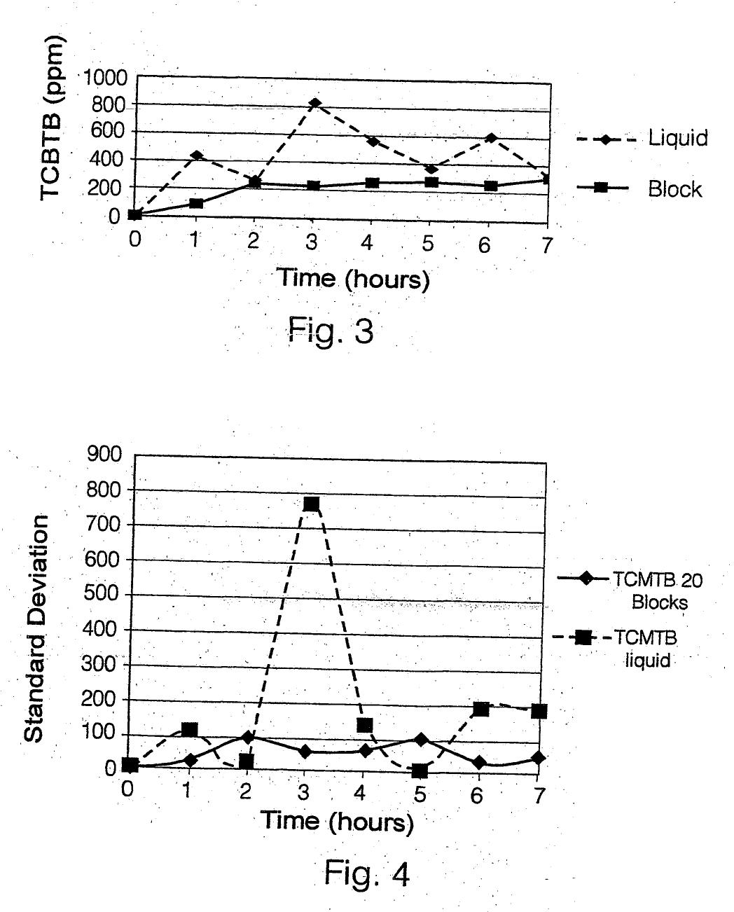

FIG. 3 is a graph illustrating the average deposition from the blocks and liquid fungicide of Example 4 respectively;

FIG. 4 indicates the standard deviations for the results in FIG. 3;

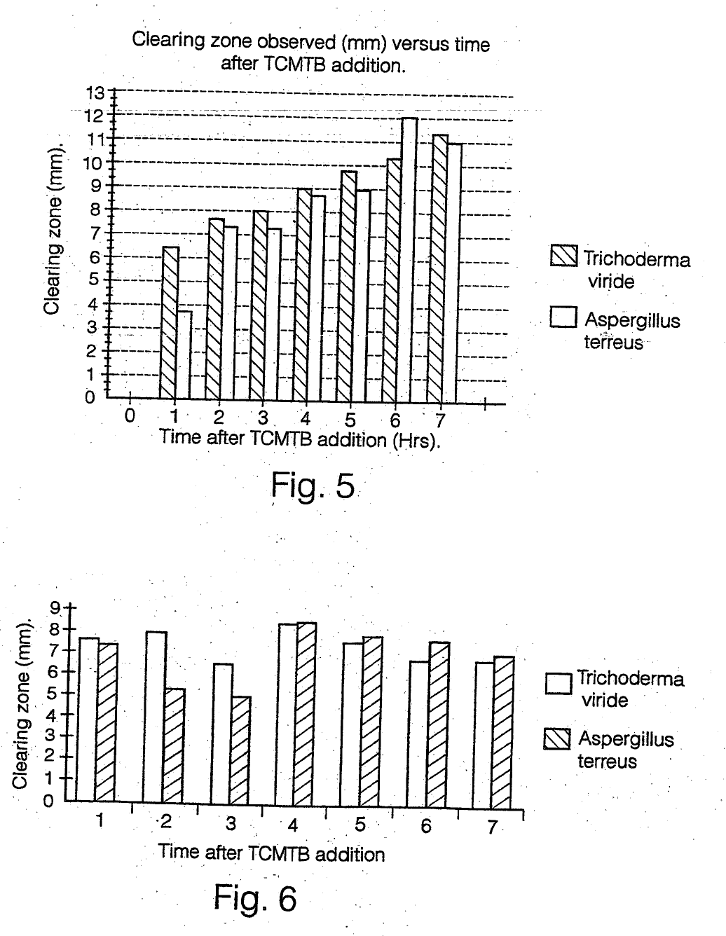

FIG. 5 illustrates fungicidal activity achieved following the use of the blocks of the invention as in Example 4; and

FIG. 6 illustrates fungicidal activity achieved following the use of TCMTB liquid, as in Example 4.

Chemical Analysis of Leather

The trend line from FIG. 1 shows a general linear increase in the concentration of TCMTB in the leather over the first five hours of the tanning process at which a maximum is obtained and maintained.

The trend line from FIG. 2 shows a general increase of TCMTB deposition over the tanning process however this can not be described as linear or consistent. These results show uneven distribution of the fungicide following addition of TCMTB as a liquid solution. FIG. 3 which compares average deposition from the two fungicide formulations (blocks or liquid) clearly shows the, uneven distribution of the TCMTB from the liquid formulation. Calculating standard deviations for the triplicate samples and comparing the two sets of data (FIG. 4) further emphasises this result.

The TCMTB concentration in the liquor samples shows a general trend of decreasing concentration over time for the blocks as compared with a consistently low TCMTB concentration when liquid TCMTB solution was used. These results are due to the rapid but uneven distribution of the TCMTB onto the leather when the liquid TCMTB formula is used as compared to the slow, linear release of the TCMTB when using the block formula.

Microbiology:

A general trend confirming increasing fungicidal activity against Aspergillus terreus and Trichoderma viride following TCMTB block addition is depicted in FIG. 5. A cleaning zone of greater than 10 mm is observed 6 hour after TCMTB block addition for both fingi tested.

No general trend for fungicidal activity can be confirmed following TCMTB liquid addition. Variation over the tanning process can be seen especially for the fingi Aspergillus terreus. The maximum cleaning zone achieved for both fungi tested is around 8.5 mm following 4 hour of treatment with the liquid fungicide. Final results show a less than 7 mm clearing zone at the end of treatment, which in the cases of both fungi tested corresponds to a difference of greater than 4 mm in clear zone as compared with TCMTB block addition and is indicative of inferior fungicidal activity from the TCMTB liquid fungicide.

1. A method of improving the distribution of an active ingredient in a tanning liquor comprising formulating tablets or blocks comprising the active ingredient dispersed in a sparingly aqueously soluble carrier and adding at least one tablet or block to the tanning liquor.

2. A method of improving the evenness of distribution in leather items of an active ingredient comprising adding the leather items to a tanning liquor, formulating tablets or blocks comprising the active ingredient dispersed in a sparingly aqueously soluble carrier, adding at least one tablet or block to the tanning liquor and agitating the blocks and the leather items to disperse the active ingredient in the tanning liquor.

3. A method as claimed in claim 1 or 2 wherein the active ingredient is a fungicide.

4. A method as claimed in claim 3 wherein the fungicide is selected from TCMTB and 2-n-octyl, 4-isothiazoline-3-one.

5. A method as claimed in any preceding claim wherein the active ingredient is present in the tablet or block in an amount of from 5% to 40% by weight.

6. A method as claimed in claim 5 wherein the active ingredient is present in an amount of about 20% weight.

7. A method as claimed in any preceding claim wherein the sparingly aqueously soluble carrier is selected from one or more long chain fatty alcohols or diols and polyalkylene oxides.

8. A method as claimed in claim 7 wherein the carrier is selected from octadecanol, 1,10-decanediol, 1,8-octanediol and 1,6-hexanediol.

9. A method as claimed in claim 2 or any claim dependent thereon wherein the leather items comprise wet blue leather.

10. A tanning process including the step of treating leather items in accordance with the method of any of claims 2 to 9.

11. A leather item produced by the method of any of claims 2 to 10.

12. A tablet or block for the addition of an active ingredient to a tanning liquor, the tablet or block comprising the active ingredient and a sparingly aqueously soluble carrier.

13. A tablet or block as claimed in claim 12 wherein the active ingredient is a fungicide.

14. A tablet or block as claimed in claim 13 wherein the fungicide is selected from TCMTB or 2-n-octyl, 4-isothiazoline-3-one.

15. A tablet or block as claimed in any of claims 12 to 15 wherein the active ingredient is present in an amount of from 5% to 40% by weight.

16. A tablet or block as claimed in claim 15 wherein the active ingredient is present in an amount of about 20% by weight.

17. A tablet or block as claimed in any of claims 12 to 16 wherein the sparingly aqueously soluble carrier is selected from one or more long chain fatty alcohols or diols and polyalkylene oxides.

18. A tablet or block as claimed in claim 17 wherein the carrier is selected from octadecanol, 1,10-decanediol, 1,8-octanediol and 1,6-hexanediol.

19. Use of a tablet as claimed in any of claims 12 to 18 in the tanning of leather.

20. Use of a tablet as claimed in any of claims 12 to 18 in a process of adding a fungicide to wet blue leather.

21. A tablet or block as claimed in claim 1, substantially or hereinbefore described.

22. A method of treating part processed leather substantially as hereinbefore described with reference to any of Examples 1 to 4.
